(19) United States
(12) Patent Application Publication
(10) Pub. No.: US 2024/0318375 A1
(43) Pub. Date: Sep. 26, 2024

(54) TEMPERATURE CONTROL METHOD AND APPARATUS FOR CLOTHES DRYER, CLOTHES DRYER AND STORAGE MEDIUM

(71) Applicants: Chongqing Haier Washing Machine Co., Ltd, Chongqing (CN); Haier Smart Home Co., Ltd, Qingdao (CN)

(72) Inventors: Kun YANG, Chongqing (CN); Zhaobin Du, Chongqing (CN); Qingguang Xu, Chongqing (CN); Delong MI, Chongqing (CN); Jichen Sun, Chongqing (CN)

(73) Assignees: Chongqing Haier Washing Machine Co., Ltd, Chongqing (CN); Haier Smart Home Co., Ltd, Qingdao (CN)

(21) Appl. No.: 18/736,350

(22) Filed: Jun. 6, 2024

Related U.S. Application Data
(63) Continuation of application No. PCT/CN2022/131177, filed on Nov. 10, 2022.

(30) Foreign Application Priority Data
Dec. 6, 2021 (CN) 202111478624.0

(51) Int. Cl. D06F 58/40; D06F 34/26; D06F 58/26; D06F 103/32; D06F 105/12; D06F 105/28

(52) U.S. Cl. CPC D06F 58/40; D06F 34/26; D06F 58/26; D06F 2103/32; D06F 2105/12; D06F 2105/28

(57) ABSTRACT

A temperature control method and apparatus for a clothes dryer, a clothes dryer, a storage medium, an electronic device and a computer program product are provided, where an instruction for drying clothes is received, an inside-drum heater is controlled to start heating until an inside-drum temperature measurement value obtained from a current measurement of an inside-drum temperature sensor reaches a first preheating temperature value preset, then the inside-drum heater is controlled to stop heating, and the clothes dryer is controlled to execute a drying control procedure according to a preset drying temperature value, where the first preheating temperature value is lower than the drying temperature value. Through setting of the first preheating temperature value, a working state of the heater of the clothes dryer is controlled.

### CROSS-REFERENCE TO RELATED APPLICATION

This application is a continuation of International Application No. PCT/CN2022/131177, filed on Nov. 10, 2022, which claims priority to Chinese Patent Application No. 202111478624.0, filed on Dec. 6, 2021. The disclosures of the aforementioned applications are hereby incorporated by reference in their entireties.

### TECHNICAL FIELD

The present application relates to the field of clothes treatment technologies, and in particular, to a temperature control method and apparatus for a clothes dryer, a clothes dryer and a storage medium.

### BACKGROUND

With the improvement of people's living standards, a clothes dryer has become an indispensable household appliance in people's daily lives. In order to meet a need of a user, control temperatures corresponding to different types of clothes may be set in the current clothes dryer.

In prior art, the manufacturer may preset an appropriate temperature value for a corresponding type of clothes in a temperature control program of the clothes dryer in advance, then an inside-drum heater of the clothes dryer may be controlled according to the temperature value preset in the clothes dryer, so as to dry corresponding clothes, thus meeting the need of the user.

Since a temperature control of the clothes dryer needs to rely on an inside-drum temperature sensor of the clothes dryer, there is a lag for the inside-drum temperature sensor to initially collect an inside-drum temperature value of the clothes dryer in a case of cold start, which causes the collected temperature value to be lower than an actual temperature value, thus the inside-drum heater cannot be controlled according to an accurate temperature value, rendering the temperature value inside the drum of the clothes dryer to be higher than the preset temperature value, and resulting in clothes damages.

### SUMMARY

The present application provides a temperature control method and apparatus for a clothes dryer, a clothes dryer and a storage medium, so as to solve the problem of clothes damage due to the fact that the clothes dryer cannot precisely control the temperature when clothes are heated by the clothes dryer.

In a first aspect, the present application provides a temperature control method for a clothes dryer, where the clothes dryer includes an inside-drum heater and an inside-drum temperature sensor;
the temperature control method includes:
receiving an instruction for drying clothes;
controlling the inside-drum heater to start heating until an inside-drum temperature measurement value obtained from a current measurement of the inside-drum temperature sensor reaches a first preheating temperature value preset, then controlling the inside-drum heater to stop heating;
controlling the clothes dryer to execute a drying control procedure according to a preset drying temperature value;
where the first preheating temperature value is lower than the drying temperature value.

In a specific implementation, the controlling the inside-drum heater to start heating includes:
configuring a start time length of the inside-drum heater as a preset time length, and configuring a heating temperature of the inside-drum heater as the drying temperature value;
controlling the inside-drum heater to start heating according to a configuration of the inside-drum heater.

In a specific implementation, the controlling the inside-drum heater to start heating includes:
configuring a heating temperature of the inside-drum heater as a second preheating temperature value;
controlling the inside-drum heater to start heating according to a configuration of the inside-drum heater;
where the second preheating temperature value is lower than the first preheating temperature value.

In a specific implementation, the controlling the clothes dryer to execute the drying control procedure according to the preset drying temperature value includes:
determining whether the inside-drum temperature measurement value obtained from the current measurement of the inside-drum temperature sensor is lower than a first execution temperature value for the drying control procedure, where the first execution temperature value for the drying control procedure is lower than the first preheating temperature value;
if the inside-drum temperature measurement value obtained from the current measurement of the inside-drum temperature sensor is lower than the first execution temperature value for the drying control procedure, controlling the clothes dryer to execute the drying control procedure according to the preset drying temperature value.

In a specific implementation, the controlling the clothes dryer to execute the drying control procedure according to the preset drying temperature value includes:
configuring a heating temperature of the inside-drum heater as the drying temperature value, controlling the inside-drum heater to start heating according to a configuration of the inside-drum heater, until it is determined that the inside-drum temperature measurement value obtained from the current measurement of the inside-drum temperature sensor reaches the drying temperature value, and controlling the inside-drum heater to stop heating;
when it is determined that the inside-drum temperature measurement value obtained from the current measurement of the inside-drum temperature sensor reaches a second execution temperature value for the drying control procedure, returning to the step of controlling the inside-drum heater to start heating according to the configuration of the inside-drum heater until the drying control procedure ends.

In a second aspect, the present application provides a temperature control apparatus for a clothes dryer, including:
a receiving module, configured to receive an instruction for drying clothes;
a first controlling module, configured to control an inside-drum heater to start heating until an inside-drum temperature measurement value obtained from a current measurement of an inside-drum temperature sensor reaches a first preheating temperature value preset, then control the inside-drum heater to stop heating;
a second controlling module, configured to control the clothes dryer to execute a drying control procedure according to a preset drying temperature value, where the first preheating temperature value is lower than the drying temperature value.

In a third aspect, the present application provides a clothes dryer, including:
a clothes dryer body and a temperature control apparatus installed on the clothes dryer body;
the temperature control apparatus is configured to control the clothes dryer body to work according to the control method for the clothes dryer according to the first aspect.

In a fourth aspect, the present application provides an electronic device, including: at least one processor and a memory;
the memory stores computer execution instructions;
the at least one processor executes the computer execution instructions stored in the memory, so that the at least one processor executes the method according to the first aspect.

In a fifth aspect, the present application provides a computer-readable storage medium, where computer execution instructions are stored in the computer-readable storage medium, and when a processor executes the computer execution instructions, the method according to the first aspect is implemented.

In a sixth aspect, the present application provides a computer program product, including a computer program, where when the computer program is executed by a processor, the method according to the first aspect is implemented.

The present application provides a temperature control method and apparatus for a clothes dryer, a clothes dryer and a storage medium, according to which an instruction for drying clothes is received, the inside-drum heater is controlled to start heating until an inside-drum temperature measurement value obtained from a current measurement of the inside-drum temperature sensor reaches a first preheating temperature value preset, then the inside-drum heater is controlled to stop heating, and the clothes dryer is controlled to execute a drying control procedure according to a preset drying temperature value, where the first preheating temperature value is lower than the drying temperature value.

Compared with the prior art, in the present application, the first preheating temperature value is set in the clothes dryer, then a working state of the heater of the clothes dryer is controlled, and a case that the temperature value collected by the inside-drum temperature sensor is relatively lower is also taken into account, thus the temperature of the clothes dryer during heating can be controlled more precisely, and occurrence of clothes damages can be avoided.

### BRIEF DESCRIPTION OF DRAWINGS

FIG. 1 is a schematic diagram of a network architecture on which the present application is based.

FIG. 2 is a schematic flowchart of a temperature control method for a clothes dryer provided in the present application.

FIG. 3 is a schematic diagram of a change trend of a temperature value inside a drum actually measured in the prior art.

FIG. 4 is a schematic diagram of a change trend of a temperature value obtained from a measurement of an inside-drum temperature sensor in the prior art.

FIG. 5 is a schematic diagram of a method for controlling start of an inside-drum heater provided in the present application.

FIG. 6 is a schematic diagram of another method for controlling start of an inside-drum heater provided in the present application.

FIG. 7 is a structural schematic diagram of a temperature control apparatus for a clothes dryer provided in the present application.

FIG. 8 is a schematic diagram of a clothes dryer provided in the present application.

FIG. 9 is a schematic diagram of a hardware structure of an electronic device provided in the present application.

### DESCRIPTION OF EMBODIMENTS

Exemplary embodiments will be described in detail here, examples of which are illustrated in accompanying drawings. When the following description refers to a drawing, unless otherwise indicated, the same number in different drawings represents the same or similar element. The embodiments described in the following exemplary embodiments do not represent all embodiments consistent with the present application. On the contrary, they are only an example of an apparatus or a method consistent with some aspects of the present application as detailed in appended claims.

With the development of clothes treatment technology and Internet of Things technology, user's demand on a household appliance is getting higher and higher, especially on a clothes dryer device which is indispensable in user's daily life. At present, a user is more concerned about how the clothes dryer controls a working state of an internal inside-drum heater according to a corresponding type of clothes, so as to realize clothes drying according to an appropriate temperature for different types of clothes, which has become a hot research topic in this field.

In the prior art, appropriate temperature values for different types of clothes are preset in a temperature control program within the clothes dryer. An inside-drum temperature value of the clothes dryer is collected through an inside-drum temperature sensor of the clothes dryer, the collected temperature value is fed back to a temperature control apparatus of the clothes dryer, and the temperature control program of the clothes dryer controls, according to the feedback temperature value, the working state of the inside-drum heater, so as to realize a drying operation on clothes.

That is to say, the clothes dryer may acquire, according to a corresponding type of clothes, a preset temperature value corresponding to the type of clothes. When the temperature value collected by the inside-drum temperature sensor is lower than the preset temperature value, the temperature control program of the clothes dryer may control the inside-drum heater to continue heating until the temperature value collected by the inside-drum temperature sensor is not lower than the preset temperature value, then control the inside-drum heater to stop heating.

After stopping heating for a period of time, when the temperature value collected by the inside-drum temperature sensor is lower than the preset temperature value again, the temperature control program may control the inside-drum heater to enter the working state of heating once again, and repeat the above process until the clothes are completely dried.

However, the problem that the temperature value collected by the inside-drum temperature sensor is relatively lower is not considered in the prior art, that is, in a case of cold start of the clothes dryer, since heating inside a drum just starts and a range of an inside-drum temperature value collected by the inside-drum temperature sensor is relatively limited, the collected temperature value is often lower than an actual temperature value in the drum of the clothes dryer, thus there would be an error in controlling the inside-drum heater by the temperature control program of the clothes dryer, as a result, the temperature inside the drum of the clothes dryer would be too high and the clothes would be damaged.

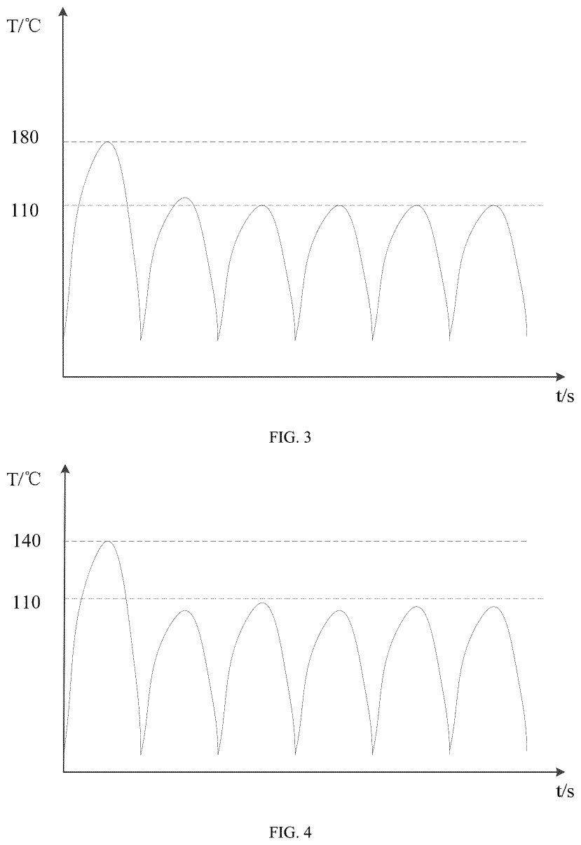

As shown in FIG. 3, FIG. 3 shows a schematic diagram of a change trend of the temperature value inside the drum actually measured in the prior art. In the coordinate system of the figure, the horizontal axis represents a time change value when the clothes dryer is in the working state, and the vertical axis represents the actual temperature value collected during heating by the inside-drum heater of the clothes dryer. It can be seen from FIG. 3 that the clothes dryer has a maximum temperature peak value short after the beginning of the start.

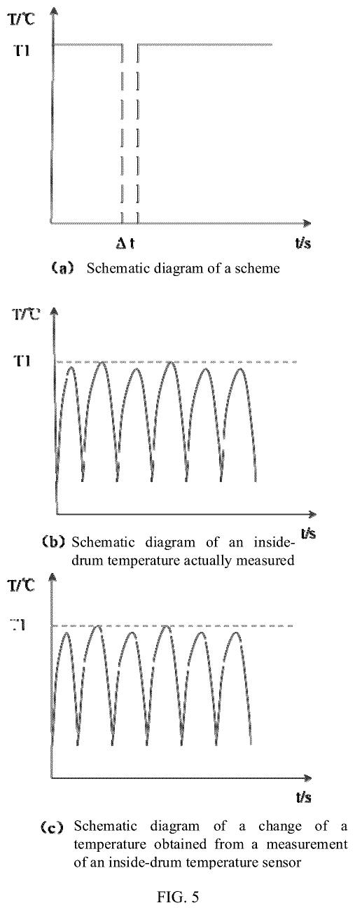

FIG. 4 shows a schematic diagram of a change trend of the temperature value obtained from a measurement of the inside-drum temperature sensor in the prior art. It can be seen from FIG. 4 that the temperature value obtained from a measurement of the inside-drum temperature sensor is lower than the temperature value in FIG. 3. In particular, the difference of the peak values of the temperature values short after the beginning of the start is relatively larger. This would easily cause the temperature inside the drum of the clothes dryer to be too high, causing damages to the clothes.

In view of such technical problem, in the present application, on considering a lag at the temperature collected by the inside-drum temperature sensor, a preset time length or a preheating temperature value for the cold start is preset in the clothes dryer, and the working state of the inside-drum heater is accurately controlled according to the preset time length or the preheating temperature value, thus the drying of different types of clothes may be completed while ensuring that the clothes are not damaged.

Specifically, the present application provides a temperature control method and apparatus for a clothes dryer, a clothes dryer and a storage medium, an instruction for drying clothes is received, the inside-drum heater is controlled to start heating until the inside-drum temperature measurement value obtained from a current measurement of the inside-drum temperature sensor reaches the first preheating temperature value preset, then the inside-drum heater is controlled to stop heating, and the clothes dryer is controlled to execute a drying control procedure according to a preset drying temperature value, where the first preheating temperature value is lower than the drying temperature value. Through setting of the first preheating temperature value, the working state of the heater of the clothes dryer is controlled. Compared with the prior art, a case that the temperature value collected by the inside-drum temperature sensor is relatively lower is also taken into account, thus the temperature of the clothes dryer during heating can be controlled more precisely, and occurrence of clothes damages can be avoided.

The technical solutions of embodiments of the present application and how the technical solutions of the present application solve the above technical problem are described in detail below with specific embodiments. The following several specific embodiments may be combined with each other, and a same or similar concept or process may not be repeated in some embodiments. The embodiments of the present application will be described below with reference to the accompanying drawings.

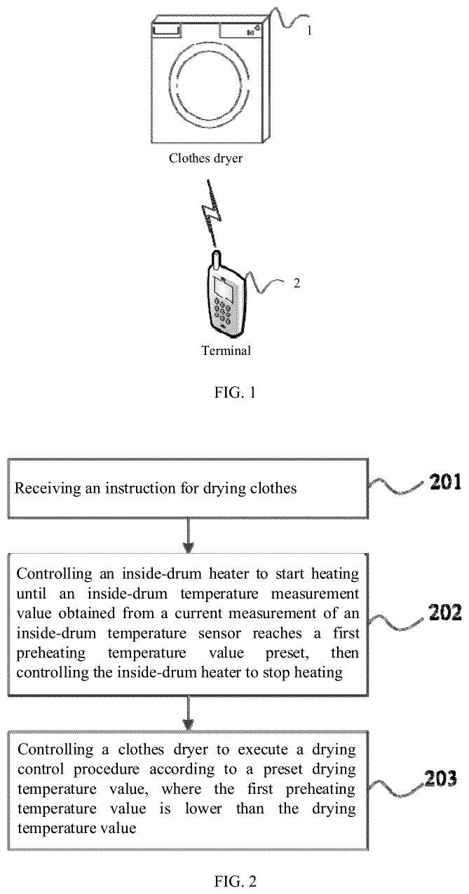

Referring to FIG. 1, FIG. 1 is a schematic diagram of a network architecture on which the present application is based. As shown in FIG. 1, the network architecture includes a clothes dryer 1 and a terminal 2.

The clothes dryer 1 is specifically a household intelligent clothes dryer, in which a temperature control apparatus for a clothes dryer provided in the present application may be integrated or installed, and the temperature control apparatus for the clothes dryer may control the clothes dryer to complete a drying treatment of different clothes based on the temperature control method for the clothes dryer provided in the present application. In addition, the clothes dryer includes an inside-drum heater and an inside-drum temperature sensor. Here, the inside-drum heater may heat the air inside the drum; the inside-drum temperature sensor may transmit the temperature of the drum to the temperature control apparatus in real time, so as to realize control of the temperature of the clothes dryer.

The terminal 2 may specifically be an intelligent communication device such as a mobile phone or a tablet computer, which may communicate with the clothes dryer 1 by using wireless sensing technologies, that is, perform an operation of sending a drying instruction to the clothes dryer, and may also be bound to the clothes dryer through an application APP installed thereon, so as to perform a corresponding operation on the clothes dryer through the terminal.

### Embodiment I

FIG. 2 is a schematic flowchart of a temperature control method for a clothes dryer provided in the present application. As shown in FIG. 2, the method includes:
step 201, receiving an instruction for drying clothes;
step 202, controlling the inside-drum heater to start heating until an inside-drum temperature measurement value obtained from a current measurement of the inside-drum temperature sensor reaches a first preheating temperature value preset, then controlling the inside-drum heater to stop heating;
step 203, controlling the clothes dryer to execute a drying control procedure according to a preset drying temperature value, where the first preheating temperature value is lower than the drying temperature value.

It should be noted that the clothes dryer provided in the present application includes the inside-drum heater and the inside-drum temperature sensor, and the temperature control method for the clothes dryer is executed by the temperature control apparatus for the clothes dryer described above. As described above, the control apparatus for the clothes dryer may be specifically installed or carried in the clothes dryer 1 described above.

Specifically, in step 201, when a user wants to use the clothes dryer to dry clothes, he/she then sends corresponding information of the drying instruction to the clothes dryer, and the clothes dryer performs corresponding operation processing according to the information of the drying instruction.

In an actual scenario, when the user needs to use the clothes dryer to dry clothes, he/she usually turns on the clothes dryer manually, via a terminal or voice information, and selects a type of the clothes to be dried by the clothes dryer, that is, sends the drying instruction to the clothes dryer.

When the clothes dryer receives the corresponding drying instruction, for example, the user sends out “I want to dry cotton clothes” and “I want to dry silk clothes” by voice, or the user selects the type of the clothes to be dried as “wool” through an APP of the terminal, then the temperature control apparatus inside the clothes dryer performs the corresponding operation processing according to the drying instruction.

In step 202, the temperature control apparatus controls the inside-drum heater to start heating until an inside-drum temperature measurement value obtained from a current measurement of the inside-drum temperature sensor reaches a first preheating temperature value preset, then controls the inside-drum heater to stop heating. Here, the first preheating temperature value is determined according to an actual environment of the clothes dryer, but is not limited thereto.

Specifically, the temperature control apparatus first controls the inside-drum heater to start heating. In an implementation, the temperature control apparatus configures a start time length of the inside-drum heater as a preset time length, and configures a heating temperature of the inside-drum heater as a drying temperature value, then controls the inside-drum heater to start heating according to the above configuration of the inside-drum heater.

In other words, in order to eliminate the problem that the temperature inside the drum is too high in the prior art, the start time length of the inside-drum heater of the clothes dryer may be improved accordingly, that is, the start time length of the inside-drum heater is determined according to the temperature inside the drum obtained from a measurement during an actual use and a relationship between a temperature value and a time in a measurement process, then the time length is configured as the preset time length for a start in the temperature control apparatus, and the heating temperature after the time length is taken as the drying temperature value in the temperature control apparatus. Here, the drying temperature value is greater than the first preheating temperature value. In the present implementation, the drying temperature value may be regarded as the first preheating temperature value.

Then, the temperature control apparatus controls the inside-drum heater to start heating according to the above configuration of the heater, that is, the temperature control apparatus determines whether the time length for the start of the inside-drum heater reaches the preset time length. If so, the drying temperature value may be reached, and the time point when the drying temperature value is reached may be taken as the time point at which the inside-drum heater stops heating.

As shown in FIG. 5, FIG. 5 is a schematic diagram of a method for controlling start of an inside-drum heater provided in the present application, that is, a schematic diagram for controlling the start of the inside-drum heater based on the preset time length and the drying temperature value. Here, the figure (a) of FIG. 5 shows the schematic diagram of the control method. In the figure, Δt represents the start time length of the inside-drum heater, i.e. the preset time length, and T1 represents the heating temperature of the heater, i.e. the drying temperature value.

It can be understood that the temperature control apparatus determines whether a working time length of the inside-drum heater reaches the preset time length through a value reported by a timer inside the clothes dryer. If the preset time length is reached, then the drying temperature value, i.e. the first preheating temperature value, is reached. At this time, the temperature control apparatus may control the inside-drum heater to stop heating.

The figure (b) of FIG. 5 shows a schematic diagram of the temperature inside the drum actually measured. It can be seen from the figure (b) of FIG. 5 that T1 is the first preheating temperature value, the change of temperature peak values is relatively uniform, and the situation that the temperature inside the drum is too high no longer exists.

The figure (c) of FIG. 5 shows a schematic diagram of the temperature inside the drum obtained from a measurement of the inside-drum temperature sensor. It can be seen from the figure (c) of FIG. 5 that a trend of the change of temperature peak values is the same as that in the (b) of FIG. 5. That is, through controlling the inside-drum heater to start heating as described in the implementation, the phenomenon that the temperature inside the drum would be too high can be avoided.

In another implementation, the temperature control apparatus may further configure the heating temperature of the inside-drum heater as a second preheating temperature value, and then control the inside-drum heater to start heating according to the configuration of the inside-drum heater. Here, the second preheating temperature value is set according to a difference relationship between a temperature value measured by the inside-drum temperature sensor and an actual temperature value inside the drum. It can be seen that the second preheating temperature value is lower than the first preheating temperature value, and the setting of the second preheating temperature value is not only limited to the one manner mentioned in the implementation.

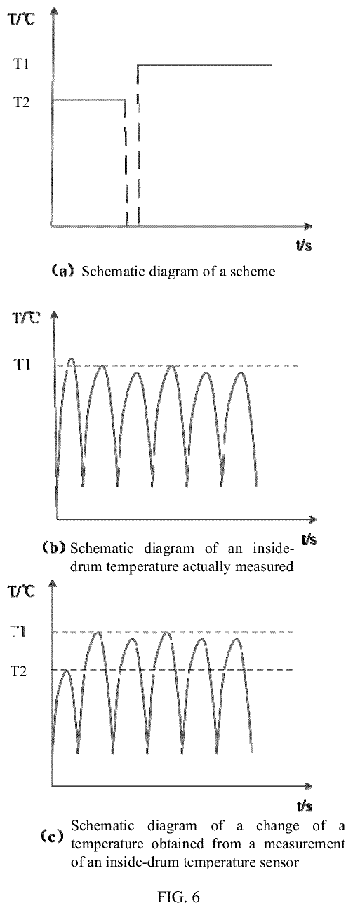

As shown in FIG. 6, FIG. 6 is a schematic diagram of another method of controlling start of an inside-drum heater provided in the present application. Here, the figure (a) of FIG. 6 shows the schematic diagram of this method, where T2 represents the second preheating temperature value and T1 represents the first preheating temperature value. It can also be understood that T2 is obtained according to a difference value between the actual temperature value inside the drum and the temperature value measured by the inside-drum temperature sensor of the clothes dryer, that is, the second preheating temperature value may be obtained by subtracting the difference value from the first preheating temperature value.

It can be understood that the temperature control apparatus controls whether to start the inside-drum heater or not according to the temperature value measured by the inside-drum temperature sensor, i.e. the second preheating temperature value. That is, when the temperature value detected by the inside-drum temperature sensor has reached the second preheating value, the temperature control apparatus controls the inside-drum heater to stop heating.

By controlling the start of the inside-drum heater according to this scheme, the results are shown in the figure (b) of FIG. 6 and the figure (c) of FIG. 6. When the first temperature peak value in the figure (c) of FIG. 6 reaches the second preheating temperature value, the first temperature peak value in the figure (b) of FIG. 6 has reached the first preheating temperature value. It can be seen that the temperature control apparatus controls the start of the inside-drum heater according to the second preheating temperature value, so the situation that the temperature inside the drum would be too high can be avoided, thus preventing the clothes from being damaged during drying of the clothes.

Specifically, the temperature control apparatus controls the inside-drum heater to start heating according to the second preheating temperature value, and when the temperature value obtained from a measurement of the inside-drum temperature sensor reaches the second preheating temperature value, the temperature control apparatus controls the inside-drum heater to stop heating; if the second preheating temperature value is not reached, the temperature control apparatus controls the heater to continue heating until the second preheating temperature value is reached.

The temperature control apparatus is configured to control the inside-drum heater to start heating according to any one of the above implementations, so the phenomenon of clothes damages caused by a too high temperature inside the drum of the clothes dryer can be avoided, so as to facilitate a subsequent processing of clothes drying. Correspondingly, in step 203, the temperature control apparatus controls the clothes dryer to execute a drying control procedure according to the preset drying temperature value.

Specifically, after the temperature control apparatus controls the inside-drum heater to stop heating for the first time, the temperature control apparatus determines, according to the temperature value obtained from a measurement of the inside-drum temperature sensor in real time, whether the inside-drum temperature measurement value obtained from the current measurement of the inside-drum temperature sensor is lower than a first execution temperature value for the drying control procedure; if so, the temperature control apparatus controls the clothes dryer to execute the drying control procedure according to the preset drying temperature value.

Here, the fact that the first execution temperature value for the drying control procedure is lower than the first preheating temperature value is taken as the basis for determining the inside-drum heater to start heating again. For example, the second preheating temperature value may be taken as the execution temperature value for the drying control procedure, and may be set according to a specific placement environment of the clothes dryer.

Further, the temperature control apparatus configures the heating temperature of the inside-drum heater as the drying temperature value, controls the inside-drum heater to start heating according to the aforementioned configuration of the inside-drum heater, until it is determined that the inside-drum temperature measurement value obtained from a current measurement of the inside-drum temperature sensor reaches the drying temperature value, then controls the inside-drum heater to stop heating.

Then, the determination of whether the inside-drum temperature measurement value obtained from a current measurement of the inside-drum temperature sensor reaches the second execution temperature value for the drying control procedure is performed again; if so, the process returns to the step of controlling the inside-drum heater to start heating according to the configuration of the inside-drum heater, that is, the execution of step 202 is repeated until the end of the drying control procedure.

Here, the second execution temperature value for the drying control procedure is an empirical value, and may be set accordingly based on a specific placement environment of the clothes dryer.

For example, the drying temperature value of the clothes dryer is 175° C., the first execution temperature value for the drying control procedure is 150° C., the second execution temperature value is 145° C., and the temperature control apparatus controls the inside-drum heater to start heating according to the drying temperature value. When the temperature value obtained from a measurement of the inside-drum temperature sensor is 175° C., the temperature control apparatus controls the inside-drum heater to stop heating.

In a subsequent process of clothes drying, after the inside-drum heater is started again or for multiple times, the temperature control apparatus obtains the temperature value measured by the inside-drum temperature sensor in real time, and when the temperature value obtained from a measurement of the temperature sensor is lower than the first execution temperature value for the drying control procedure, i.e. 150° C., the temperature control apparatus controls the inside-drum heater to stop heating.

Similarly, during the time when heating is stopped, when the temperature value obtained from a measurement of the inside-drum temperature sensor has reached the second execution temperature value for the drying control procedure, i.e. 145° C., if so, the temperature control apparatus controls the inside-drum heater to continue heating until the first execution temperature value for the drying control procedure is reached.

The above operation steps are repeated until the drying control procedure ends, and the drying treatment for the clothes is completed.

According to the temperature control method for the clothes dryer provided in the present application, the instruction for drying clothes is received, the inside-drum heater is controlled to start heating until the inside-drum temperature measurement value obtained from a current measurement of the inside-drum temperature sensor reaches the first preheating temperature value preset, then the inside-drum heater is controlled to stop heating, and the clothes dryer is controlled to execute the drying control procedure according to the preset drying temperature value, where the first preheating temperature value is lower than the drying temperature value. Through setting of the first preheating temperature value, a working state of the heater of the clothes dryer is controlled. Compared with the prior art, a case that the temperature value collected by the inside-drum temperature sensor is relatively lower is also taken into account, thus the temperature of the clothes dryer during heating can be controlled more precisely, and occurrence of clothes damages can be avoided.

### Embodiment II

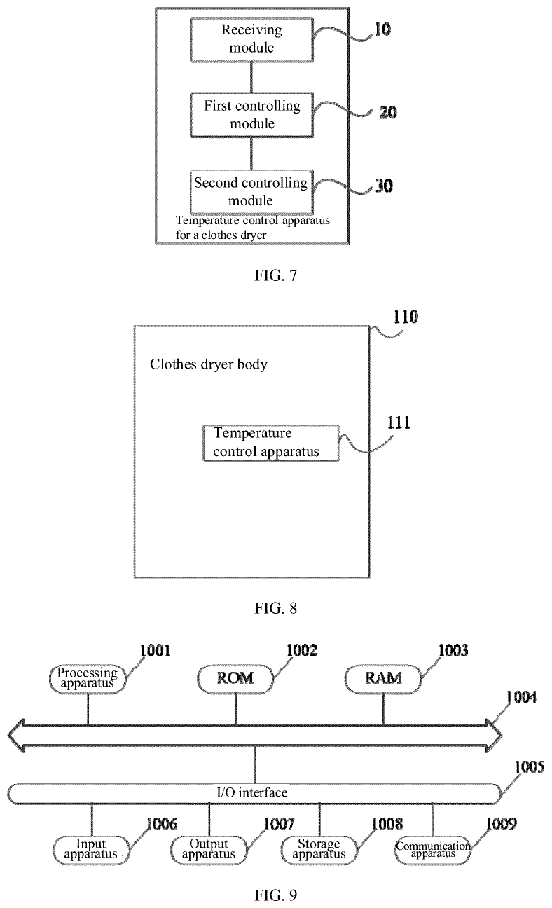

Corresponding to the temperature control method for the clothes dryer of the present application, FIG. 7 is a structural schematic diagram of a temperature control apparatus for the clothes dryer provided in the present application. For ease of illustration, only portions relevant to the present application are shown.

Referring to FIG. 7, the temperature control apparatus for the clothes dryer includes:
a receiving module 10, configured to receive an instruction for drying clothes;
a first controlling module 20, configured to control an inside-drum heater to start heating until an inside-drum temperature measurement value obtained from a current measurement of an inside-drum temperature sensor reaches a first preheating temperature value preset, then control the inside-drum heater to stop heating;
a second controlling module 30, configured to control the clothes dryer to execute a drying control procedure according to a preset drying temperature value, where the first preheating temperature value is lower than the drying temperature value.

In an implementation, the clothes dryer includes the inside-drum heater and the inside-drum temperature sensor.

In an implementation, the first controlling module 20 is specifically configured to:
configure a start time length of the inside-drum heater as a preset time length, and configure a heating temperature of the inside-drum heater as the drying temperature value;
control the inside-drum heater to start heating according to a configuration of the inside-drum heater.

In an implementation, the first controlling module 20 is further configured to:
configure a heating temperature of the inside-drum heater as a second preheating temperature value;
control the inside-drum heater to start heating according to a configuration of the inside-drum heater;
where the second preheating temperature value is lower than the first preheating temperature value.

In an implementation, the second controlling module 30 is further configured to: determine whether the inside-drum temperature measurement value obtained from the current measurement of the inside-drum temperature sensor is lower than a first execution temperature value for the drying control procedure, where the first execution temperature value for the drying control procedure is lower than the first preheating temperature value;
if yes, control the clothes dryer to execute the drying control procedure according to the preset drying temperature value.

In an implementation, the second controlling module 30 is further configured to:
configure a heating temperature of the inside-drum heater as the drying temperature value, control the inside-drum heater to start heating according to a configuration of the inside-drum heater, until it is determined that the inside-drum temperature measurement value obtained from the current measurement of the inside-drum temperature sensor reaches the drying temperature value, and control the inside-drum heater to stop heating;
when it is determined that the inside-drum temperature measurement value obtained from the current measurement of the inside-drum temperature sensor reaches a second execution temperature value for the drying control procedure, return to the step of controlling the inside-drum heater to start heating according to the configuration of the inside-drum heater until the drying control procedure ends.

The implementation principle of the temperature control apparatus for the clothes dryer provided in the present application is similar to that in any of the above embodiments, and will not be repeated here.

According to the temperature control apparatus for the clothes dryer provided in the present application, the instruction for drying clothes received, the inside-drum heater is controlled to start heating until the inside-drum temperature measurement value obtained from a current measurement of the inside-drum temperature sensor reaches the first preheating temperature value preset, then the inside-drum heater is controlled to stop heating, and the clothes dryer is controlled to execute the drying control procedure according to the preset drying temperature value, where the first preheating temperature value is lower than the drying temperature value. Through setting of the first preheating temperature value, a working state of the heater of the clothes dryer is controlled. Compared with the prior art, a case that the temperature value collected by the inside-drum temperature sensor is relatively lower is also taken into account, thus the temperature of the clothes dryer during heating can be controlled more precisely, and occurrence of clothes damages can be avoided.

### Embodiment III

Corresponding to the temperature control method for the clothes dryer of the present application, FIG. 8 is a schematic diagram of a clothes dryer provided in the present application. For ease of illustration, only portions relevant to the present application are shown.

Referring to FIG. 8, the clothes dryer includes:
a clothes dryer body 110 and a temperature control apparatus 111 installed on the clothes dryer body.

In an implementation, the clothes dryer body 110 includes an inside-drum heater and an inside-drum temperature sensor.

In an implementation, the clothes dryer body 110 is specifically configured to:
carry the temperature control apparatus 111 on the clothes dryer;
carry out a communication with a terminal 2.

In an implementation, the temperature control apparatus 111 is specifically configured to:
receive an instruction for drying clothes;
control an inside-drum heater to start heating until an inside-drum temperature measurement value obtained from a current measurement of an inside-drum temperature sensor reaches a first preheating temperature value preset, then control the inside-drum heater to stop heating;
control the clothes dryer to execute a drying control procedure according to a preset drying temperature value;
where the first preheating temperature value is lower than the drying temperature value.

In an implementation, the temperature control apparatus 111 is further configured to:
configure a start time length of the inside-drum heater as a preset time length, and configure a heating temperature of the inside-drum heater as the drying temperature value;
control the inside-drum heater to start heating according to a configuration of the inside-drum heater.

In an implementation, the temperature control apparatus 111 is further configured to:
configure a heating temperature of the inside-drum heater as a second preheating temperature value;
control the inside-drum heater to start heating according to a configuration of the inside-drum heater;
where the second preheating temperature value is lower than the first preheating temperature value.

In an implementation, the temperature control apparatus 111 is further configured to:
determine whether the inside-drum temperature measurement value obtained from the current measurement of the inside-drum temperature sensor is lower than a first execution temperature value for the drying control procedure, where the first execution temperature value for the drying control procedure is lower than the first preheating temperature value;
if yes, control the clothes dryer to execute the drying control procedure according to the preset drying temperature value.

In an implementation, the temperature control apparatus 111 is further configured to:
configure a heating temperature of the inside-drum heater as the drying temperature value, control the inside-drum heater to start heating according to a configuration of the inside-drum heater, until it is determined that the inside-drum temperature measurement value obtained from the current measurement of the inside-drum temperature sensor reaches the drying temperature value, and control the inside-drum heater to stop heating;
when it is determined that the inside-drum temperature measurement value obtained from the current measurement of the inside-drum temperature sensor reaches a second execution temperature value for the drying control procedure, return to the step of controlling the inside-drum heater to start heating according to the configuration of the inside-drum heater until the drying control procedure ends.

According to the clothes dryer provided by the present application, the instruction for drying clothes is received, the inside-drum heater is controlled to start heating until the inside-drum temperature measurement value obtained from a current measurement of the inside-drum temperature sensor reaches the first preheating temperature value preset, then the inside-drum heater is controlled to stop heating, and the clothes dryer is controlled to execute the drying control procedure according to the preset drying temperature value, where the first preheating temperature value is lower than the drying temperature value. Through setting of the first preheating temperature value, a working state of the heater of the clothes dryer is controlled. Compared with the prior art, a case that the temperature value collected by the inside-drum temperature sensor is relatively lower is also taken into account, thus the temperature of the clothes dryer during heating can be controlled more precisely, and occurrence of clothes damages can be avoided.

### Embodiment IV

An electronic device provided in the present application may be used to execute the technical solutions of the above method embodiments. FIG. 9 is a schematic diagram of a hardware structure of the electronic device provided in the present application. For ease of illustration, only portions relevant to the present application are shown.

Referring to FIG. 9, which shows the structural schematic diagram of the electronic device 1000 suitable for implementing embodiments of the present application. The electronic device 1000 may be a central control terminal device. The electronic device shown in FIG. 9 is merely an example, and it should not bring about any limitation to the function and use scope of embodiments of the present application.

As shown in FIG. 9, the electronic device 1000 may include an output apparatus (e.g., a central processing unit, a graphics processing unit, etc.) 1007, which may perform various appropriate actions and processing according to a program stored in a read only memory (Read Only Memory, ROM) 1002 or a program loaded from a storage apparatus 1008 into a random access memory (Random Access Memory, RAM) 1003. In the RAM 1003, various programs and data necessary for an operation of the electronic device 1000 are also stored. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, e.g., a touch screen, a touch pad, a keyboard, a mouse, a camera, a microphone, an accelerometer, a gyroscope, etc.; an output apparatus 1007 including, e.g., a liquid crystal display (Liquid Crystal Display, LCD), a speaker, a vibrator, etc.; a storage apparatus 1008 including, e.g., a tape, a hard disk, etc.; and a communication apparatus 1009. The communication apparatus 1009 may allow the electronic device 1000 to perform wireless or wired communication with other devices to exchange data. Although FIG. 9 shows an electronic device 1000 with various apparatuses, it should be understood that it is not a requirement to implement or be equipped with all of the shown apparatuses. More or fewer apparatuses may alternatively be implemented or equipped with.

Specifically, according to embodiments of the present application, the process described above with reference to a flowchart may be implemented as a computer software program. For example, an embodiment of the present application includes a computer program product, which includes a computer program carried on a computer-readable medium, where the computer program includes program code for performing the method illustrated in the flowchart. In such an embodiment, the computer program may be downloaded and installed from a network through the communication apparatus 1009, or installed from the storage apparatus 1008, or installed from the ROM 1002. When the computer program is executed by the processing apparatus 1001, the above functions defined in the method of embodiments of the present application are performed.

It should be noted that the computer-readable medium described above in the present application may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In the present application, the computer-readable storage medium may be any tangible medium that contains or stores a program for use by or in connection with an instruction execution system, apparatus, or device. In the present application, the computer-readable signal medium may include a data signal propagated in baseband or as part of a carrier wave, in which computer-readable program code is carried. Such a propagated data signal may take a variety of forms including, but not limited to, an electromagnetic signal, an optical signal, or any suitable combination of the foregoing. The computer-readable signal medium, which can transmit, propagate, or transport a program for use by or in connection with an instruction execution system, apparatus, or device, may also be any computer-readable medium other than a computer-readable storage medium. The program code embodied on the computer-readable medium may be transmitted using any appropriate medium, including but not limited to: a wire, an optical cable, a RF (radio frequency), etc., or any suitable combination of the foregoing.

The computer-readable medium may be included in the electronic device, or may exist alone without being assembled into the electronic device.

The computer-readable medium carries one or more programs, and when the one or more programs are executed by the electronic device, the electronic device performs the methods shown in the foregoing embodiments.

The present application provides the computer program product in which computer program code for carrying out operations of the present disclosure may be written in one or more programming languages, including object-oriented programming languages such as Java, Smalltalk, C++, and regular procedural programming languages such as the “C” language or similar programming languages, or a combination thereof. The program code may execute entirely on a user computer, partly on the user computer, as a stand-alone software package, partly on the user computer and partly on a remote computer, or entirely on the remote computer or media library. In the case of a remote computer, the remote computer may be connected to a user computer through any type of network, including a local area network (Local Area Network, LAN) or a wide area network (Wide Area Network, WAN), or it may be connected to an external computer (for example, through the Internet using an Internet service provider).

The flowcharts and block diagrams in the accompanying drawings illustrate architectures, functions, and operations of possible implementations of systems, methods, and computer program products according to various embodiments of the present application. In this regard, each block in the flowchart or block diagram may represent a module, a program segment, or a portion of code, which contains one or more executable instructions for implementing the specified logical functions. It should also be noted that in some alternative implementations, the functions noted in the blocks may also occur in a different order than noted in the figures. For example, two blocks shown in succession may in fact be executed substantially in parallel, or they may sometimes be executed in the reverse order, depending on the functionality involved. It is also noted that each block in the block diagrams and/or flowcharts, and combinations of blocks in the block diagrams and/or flowcharts, can be implemented with dedicated hardware-based systems that perform the specified functions or operations, or can be implemented with a combination of dedicated hardware and computer instructions.

The units described in the embodiments of the present application may be implemented in a software manner, or may be implemented in a hardware manner. The name of the unit does not constitute a limitation on the unit itself under certain circumstances. For example, the first controlling module may also be described as “a module for controlling an inside-drum heater”.

The functions described herein above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system on a chip (SOCs), complex programmable logic devices (CPLDs), etc.

In the context of the present application, a machine-readable medium may be a tangible medium that can contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

Other embodiments of the present application will readily occur to those skilled in the art upon consideration of the specification and practice of the disclosure disclosed herein. The present application is intended to cover any variation, use or adaptive change of the present application, and these variations, uses or adaptive changes follow the general principles of the present application and include the common general knowledge or customary technical means not disclosed in the present application in the technical field. It is intended that the specification and examples are considered as exemplary only, with a true scope and spirit of the application being indicated by the following claims.

It should be understood that the present application is not limited to the precise structure that has been described above and illustrated in the accompanying drawings, and that various modifications and changes may be made without departing from the scope thereof. The scope of the present application is limited only by the appended claims.

What is claimed is:

1. A temperature control method for a clothes dryer, wherein the clothes dryer comprises an inside-drum heater and an inside-drum temperature sensor;
the temperature control method comprises:
receiving an instruction for drying clothes;
controlling the inside-drum heater to start heating until an inside-drum temperature measurement value obtained from a current measurement of the inside-drum temperature sensor reaches a first preheating temperature value preset, then controlling the inside-drum heater to stop heating;
controlling the clothes dryer to execute a drying control procedure according to a preset drying temperature value;
wherein the first preheating temperature value is lower than the drying temperature value.

2. The temperature control method according to claim 1, wherein the controlling the inside-drum heater to start heating comprises:
configuring a start time length of the inside-drum heater as a preset time length, and configuring a heating temperature of the inside-drum heater as the drying temperature value;
controlling, according to a configuration of the inside-drum heater, the inside-drum heater to start heating.

3. The temperature control method according to claim 1, wherein the controlling the inside-drum heater to start heating comprises:
configuring a heating temperature of the inside-drum heater as a second preheating temperature value;
controlling, according to a configuration of the inside-drum heater, the inside-drum heater to start heating;
wherein the second preheating temperature value is lower than the first preheating temperature value.

4. The temperature control method according to claim 1, wherein the controlling the clothes dryer to execute the drying control procedure according to the preset drying temperature value comprises:
determining whether the inside-drum temperature measurement value obtained from the current measurement of the inside-drum temperature sensor is lower than a first execution temperature value for the drying control procedure, wherein the first execution temperature value for the drying control procedure is lower than the first preheating temperature value;
if the inside-drum temperature measurement value obtained from the current measurement of the inside-drum temperature sensor is lower than the first execution temperature value for the drying control procedure, controlling the clothes dryer to execute the drying control procedure according to the preset drying temperature value.

5. The temperature control method according to claim 1, wherein the controlling the clothes dryer to execute the drying control procedure according to the preset drying temperature value comprises:
configuring a heating temperature of the inside-drum heater as the drying temperature value, controlling, according to a configuration of the inside-drum heater, the inside-drum heater to start heating, until it is determined that the inside-drum temperature measurement value obtained from the current measurement of the inside-drum temperature sensor reaches the drying temperature value, and controlling the inside-drum heater to stop heating;
when it is determined that the inside-drum temperature measurement value obtained from the current measurement of the inside-drum temperature sensor reaches a second execution temperature value for the drying control procedure, returning to the step of controlling, according to the configuration of the inside-drum heater, the inside-drum heater to start heating until the drying control procedure ends.

6. An electronic device, comprising: at least one processor and a memory;
the memory stores computer execution instructions;
the at least one processor executes the computer execution instructions stored in the memory; wherein the computer execution instructions, when executed by the at least one processor, cause the at least one processor to:
receive an instruction for drying clothes;
control an inside-drum heater to start heating until an inside-drum temperature measurement value obtained from a current measurement of an inside-drum temperature sensor reaches a first preheating temperature value preset, then control the inside-drum heater to stop heating;
control a clothes dryer to execute a drying control procedure according to a preset drying temperature value, wherein the first preheating temperature value is lower than the drying temperature value.

7. The electronic device according to claim 6, wherein the computer execution instructions cause the at least one processor to:
configure a start time length of the inside-drum heater as a preset time length, and configure a heating temperature of the inside-drum heater as the drying temperature value;
control, according to a configuration of the inside-drum heater, the inside-drum heater to start heating.

8. The electronic device according to claim 6, wherein the computer execution instructions cause the at least one processor to:
configure a heating temperature of the inside-drum heater as a second preheating temperature value;
control, according to a configuration of the inside-drum heater, the inside-drum heater to start heating;
wherein the second preheating temperature value is lower than the first preheating temperature value.

9. The electronic device according to claim 6, wherein the computer execution instructions cause the at least one processor to:
determine whether the inside-drum temperature measurement value obtained from the current measurement of the inside-drum temperature sensor is lower than a first execution temperature value for the drying control procedure, wherein the first execution temperature value for the drying control procedure is lower than the first preheating temperature value;
if the inside-drum temperature measurement value obtained from the current measurement of the inside-drum temperature sensor is lower than the first execution temperature value for the drying control procedure, control the clothes dryer to execute the drying control procedure according to the preset drying temperature value.

10. The electronic device according to claim 6, wherein the computer execution instructions cause the at least one processor to:
configure a heating temperature of the inside-drum heater as the drying temperature value, control, according to a configuration of the inside-drum heater, the inside-drum heater to start heating, until it is determined that the inside-drum temperature measurement value obtained from the current measurement of the inside-drum temperature sensor reaches the drying temperature value, and control the inside-drum heater to stop heating;
when it is determined that the inside-drum temperature measurement value obtained from the current measurement of the inside-drum temperature sensor reaches a second execution temperature value for the drying control procedure, return to the step of controlling, according to the configuration of the inside-drum heater, the inside-drum heater to start heating until the drying control procedure ends.

11. A clothes dryer, comprising:
a clothes dryer body and a temperature control apparatus installed on the clothes dryer body;
the temperature control apparatus is configured to control the clothes dryer body to:
receive an instruction for drying clothes;
control an inside-drum heater to start heating until an inside-drum temperature measurement value obtained from a current measurement of an inside-drum temperature sensor reaches a first preheating temperature value preset, then control the inside-drum heater to stop heating;
control the clothes dryer to execute a drying control procedure according to a preset drying temperature value, wherein the first preheating temperature value is lower than the drying temperature value.

12. The clothes dryer according to claim 11, wherein the temperature control apparatus is configured to control the clothes dryer body to:
configure a start time length of the inside-drum heater as a preset time length, and configure a heating temperature of the inside-drum heater as the drying temperature value;
control, according to a configuration of the inside-drum heater, the inside-drum heater to start heating.

13. The clothes dryer according to claim 11, wherein the temperature control apparatus is configured to control the clothes dryer body to:
configure a heating temperature of the inside-drum heater as a second preheating temperature value;
control, according to a configuration of the inside-drum heater, the inside-drum heater to start heating;
wherein the second preheating temperature value is lower than the first preheating temperature value.

14. The clothes dryer according to claim 11, wherein the temperature control apparatus is configured to control the clothes dryer body to:
determine whether the inside-drum temperature measurement value obtained from the current measurement of the inside-drum temperature sensor is lower than a first execution temperature value for the drying control procedure, wherein the first execution temperature value for the drying control procedure is lower than the first preheating temperature value;
if the inside-drum temperature measurement value obtained from the current measurement of the inside-drum temperature sensor is lower than the first execution temperature value for the drying control procedure, control the clothes dryer to execute the drying control procedure according to the preset drying temperature value.

15. The clothes dryer according to claim 11, wherein the temperature control apparatus is configured to control the clothes dryer body to:
configure a heating temperature of the inside-drum heater as the drying temperature value, control, according to a configuration of the inside-drum heater, the inside-drum heater to start heating, until it is determined that the inside-drum temperature measurement value obtained from the current measurement of the inside-drum temperature sensor reaches the drying temperature value, and control the inside-drum heater to stop heating;
when it is determined that the inside-drum temperature measurement value obtained from the current measurement of the inside-drum temperature sensor reaches a second execution temperature value for the drying control procedure, return to the step of controlling, according to the configuration of the inside-drum heater, the inside-drum heater to start heating until the drying control procedure ends.

16. A non-transitory computer-readable storage medium, wherein computer execution instructions are stored in the non-transitory computer-readable storage medium, and when a processor executes the computer execution instructions, the method according to claim 1 is implemented.

17. The non-transitory computer-readable storage medium according to claim 16, wherein the controlling the inside-drum heater to start heating comprises:
configuring a start time length of the inside-drum heater as a preset time length, and configuring a heating temperature of the inside-drum heater as the drying temperature value;
controlling, according to a configuration of the inside-drum heater, the inside-drum heater to start heating.

18. The non-transitory computer-readable storage medium according to claim 16, wherein the controlling the inside-drum heater to start heating comprises:
configuring a heating temperature of the inside-drum heater as a second preheating temperature value;
controlling, according to a configuration of the inside-drum heater, the inside-drum heater to start heating;
wherein the second preheating temperature value is lower than the first preheating temperature value.

19. The non-transitory computer-readable storage medium according to claim 16, wherein the controlling the clothes dryer to execute the drying control procedure according to the preset drying temperature value comprises:
determining whether the inside-drum temperature measurement value obtained from the current measurement of the inside-drum temperature sensor is lower than a first execution temperature value for the drying control procedure, wherein the first execution temperature value for the drying control procedure is lower than the first preheating temperature value;
if the inside-drum temperature measurement value obtained from the current measurement of the inside-drum temperature sensor is lower than the first execution temperature value for the drying control procedure, controlling the clothes dryer to execute the drying control procedure according to the preset drying temperature value.

20. The non-transitory computer-readable storage medium according to claim 16, wherein the controlling the clothes dryer to execute the drying control procedure according to the preset drying temperature value comprises:
configuring a heating temperature of the inside-drum heater as the drying temperature value, controlling, according to a configuration of the inside-drum heater, the inside-drum heater to start heating, until it is determined that the inside-drum temperature measurement value obtained from the current measurement of the inside-drum temperature sensor reaches the drying temperature value, and controlling the inside-drum heater to stop heating;
when it is determined that the inside-drum temperature measurement value obtained from the current measurement of the inside-drum temperature sensor reaches a second execution temperature value for the drying control procedure, returning to the step of controlling, according to the configuration of the inside-drum heater, the inside-drum heater to start heating until the drying control procedure ends.
